(19) United States
(12) Patent Application Publication
(10) Pub. No.: US 2025/0390371 A1
(43) Pub. Date: Dec. 25, 2025

(54) CORE ISOLATION FOR ERRORS

(71) Applicant: Advanced Micro Devices, Inc., Santa Clara, CA (US)

(72) Inventors: Vilas Sridharan, Boxborough, MA (US); Ruchir Dalal, Austin, TX (US); Marius Evers, Santa Clara, CA (US); Eric Christopher Morton, Austin, TX (US)

(73) Assignee: Advanced Micro Devices, Inc., Santa Clara, CA (US)

(21) Appl. No.: 18/750,837

(22) Filed: Jun. 21, 2024

(51) Int. Cl. G06F 11/07; G06F 9/30; G06F 11/14

(52) U.S. Cl. CPC G06F 11/0772; G06F 9/3009; G06F 11/1417

(57) ABSTRACT

The disclosed device includes a controller that can receive an error interrupt for a thread, and isolate the thread. The controller can also notify a partner thread of the isolated thread. The partner thread can report the isolation to an operating system or other controller. Isolating the thread can avoid halting other unaffected threads. Various other methods, systems, and computer-readable media are also disclosed.

### BACKGROUND

A computing device has various mechanisms to address hardware faults, such as faults relating to a processor core (e.g., a processing unit of a central processing unit (CPU) which may have multiple processing units). For instance, an interrupt system allows interrupts to take precedence over normal program instruction execution. Further, a system such as Machine Check Architecture (MCA) allows detecting and reporting hardware errors to an operating system of the computing device. MCA can include certain model-specific registers (MSR) in the computing device used for machine checking as well as recording errors. Certain errors, such as errors causing corruption of shared system resources (e.g., a cache and/or memory sub-system) require a system shutdown/reboot. However, the system shutdown response can be undesirable and unnecessary for certain errors that has not corrupted shared system resources.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for core isolation for errors.

FIG. 2 is a diagram of exemplary threads representing cores.

FIG. 3 is a diagram of an exemplary windowed register.

FIG. 4 is a diagram of exemplary partner thread mapping.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims. FIG. 5 is a flow diagram of an exemplary method for . . . .

### DETAILED DESCRIPTION

The present disclosure is generally directed to core isolation for core errors. As will be explained in greater detail below, implementations of the present disclosure can mark a thread (corresponding to a core) as isolated in response to an error interrupt for the thread. A partner thread of the isolated thread can report the isolation status of the isolated thread to an operating system. Isolating the thread can advantageously prevent and/or stop a nested error scenario (e.g., where errors cause more errors in a loop) such that a system shutdown can be avoided, and unaffected workloads can continue. Having a partner thread further advantageously avoids requiring a faulty thread to report its own error. Accordingly, the systems and methods described herein provides more efficient processing of a computing device by isolating hardware (core) errors and avoiding system shutdown.

In one implementation, a device for core isolation for errors includes a control circuit configured to mark a thread as isolated in response to an error interrupt corresponding to the thread, and send a notification of isolating the thread to a partner thread of the isolated thread.

In some examples, the device includes a register for storing an isolation status for threads, wherein the control circuit is configured to mark the isolated thread as isolated in the register. In some examples, the register corresponds to a windowed register. In some examples, the register is configured to maintain isolation statuses for all threads.

In some examples, the device includes a register for storing partner mappings. In some examples, the control circuit is further configured to identify the partner thread based on the partner mappings in the register.

In one implementation, a system for core isolation for errors includes a plurality of processor cores corresponding to threads, a first register for storing an isolation status for the threads, a second register for storing partner mappings for the threads, and a control circuit. In some examples, the control circuit configured to (i) mark a thread as isolated in the first register in response to an error interrupt corresponding to the thread, (ii) identify a partner thread of the isolated thread based on the second register, and (iii) send a notification of isolating the thread to the partner thread of the isolated thread.

In some examples, an operating system of the system establishes the partner mappings on a boot of the system. In some examples, the partner thread is configured to report the isolated thread to the operating system.

In some examples, the control circuit is configured to decline execution-related requests to the isolated thread. In some examples, the first register is configured to maintain isolation statuses for all threads. In some examples, the partner thread is configured to identify the isolation status from the first register in response to the notification. In some examples, the partner thread is further configured to identify the isolation status from the first register based on identifying a partner mapping in the second register. In some examples, the first register corresponds to a windowed register.

In one implementation, a method for core isolation for errors includes (i) receiving an error interrupt for a thread corresponding to a processor core, (ii) marking the thread as isolated in response to the error interrupt, (iii) notifying a partner thread of the isolated thread, and (iv) preventing the isolated thread from performing a context switch.

In some examples, the method includes reporting an isolation status of the isolated thread. In some examples, marking the thread as isolated further includes marking the thread as isolated in a register configured to store isolation statuses of threads. In some examples, reporting the isolation status of the isolated thread includes identifying, by the partner thread, the isolation status from the register. In some examples, notifying the partner thread includes identifying the partner thread of the isolated thread from a register configured to store partner mappings for threads. In some examples, reporting the isolation status includes identifying, by the partner thread, the isolated thread based on the partner mappings in the register.

Features from any of the implementations described herein can be used in combination with one another in accordance with the general principles described herein. These and other implementations, features, and advantages will be more fully understood upon reading the following detailed description in conjunction with the accompanying drawings and claims.

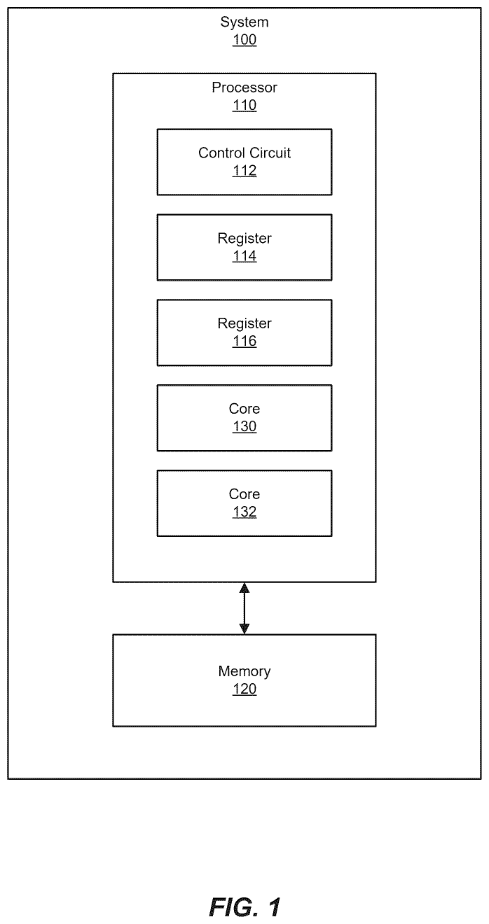

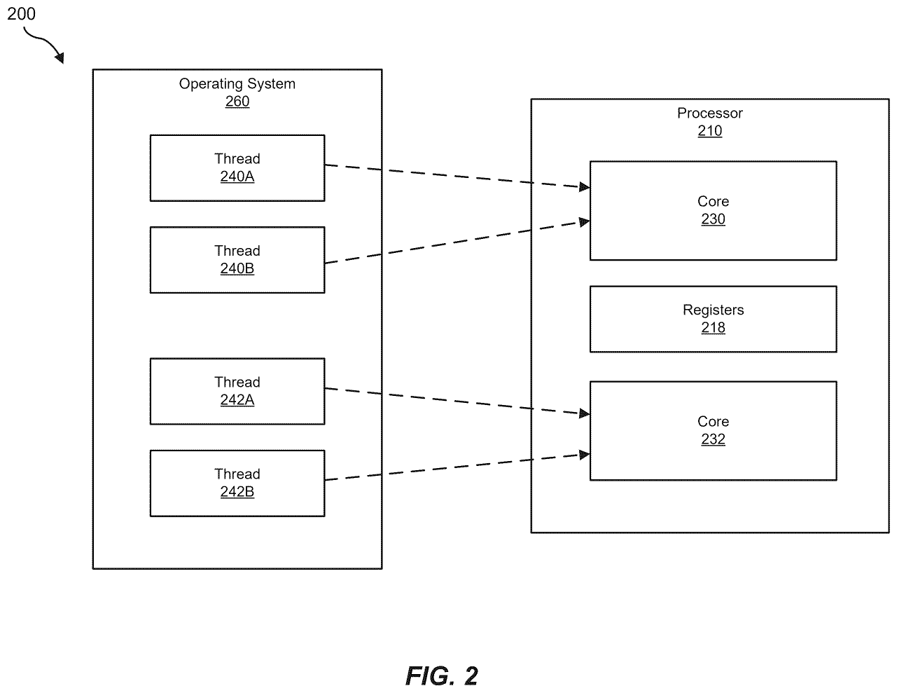

The following will provide, with reference to FIGS. 1-5, detailed descriptions of systems and methods of core isolation for hardware errors. Detailed descriptions of example systems will be provided in connection with FIG. 1. Detailed descriptions of isolation status and partner thread mapping will be provided in connection with FIGS. 2-4. In addition, detailed descriptions of corresponding methods will also be provided in connection with FIG. 5.

FIG. 1 is a block diagram of an example system 100 for core isolation for hardware errors. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s).

Further, in some implementations processor 110 can include or otherwise generally represent a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in memory 120. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

As further illustrated in FIG. 1, processor 110 includes a control circuit 112, a register 114, a register 116, a core 130, and a core 132. In some examples, control circuit 112 corresponds to a controller and includes circuitry and/or instructions for managing aspects of hardware error system (e.g., MCA). In some implementations, control circuit 112 can be integrated with and/or otherwise represent a data fabric (e.g., data pipelines and/or related controllers and interfaces for using and managing data resources such as memory 120, a cache, etc.). Register 114 and register 116 can each correspond to a local storage device of processor 110 for maintaining aspects of isolation statuses, as will be described further below, and in some implementations can correspond to one or more MSRs. Core 130 and core 132 can each correspond to one or more physical processor cores of processor 110 (e.g., such that processor 110 can include more cores than illustrated), which in some implementations can be mapped as threads. In some examples, a thread represents a virtual core, allowing an operating system of a computing device to divide a physical core into one or more virtual cores to allocate tasks. Moreover, in some examples, a thread can represent a virtual machine, for instance in a system having multiple virtual machines managed by a hypervisor. In some implementations, an operating system/hypervisor can logically map virtual cores to the physical cores, and the physical cores can manage resources for executing tasks for the threads, as will be described further with respect to FIG. 2.

FIG. 2 illustrates a system 200 corresponding to system 100. System 200 includes a processor 210 corresponding to processor 110, a core 230 corresponding to core 130, and a core 232 corresponding to core 132. As further illustrated in FIG. 2, processor 210 includes registers 218 corresponding to one or more registers. FIG. 2 also illustrates an operating system 260 (e.g., an operating system of system 200 which can further correspond to a hypervisor for virtual machines, a virtual machine, a firmware, and/or other computing resource management) that can manage a thread 240A, a thread 240B, a thread 242A, and a thread 242B. Each of the threads (e.g., threads 240A, 240B, 242A, and/or 242B) can correspond to a thread mapped to a physical core. More specifically, thread 240A and thread 240B can be mapped to core 230, and thread 242A and thread 242B can be mapped to core 232, although in other examples, other mappings and/or number of threads and/or cores can be used.

As operating system 260 assigns tasks to the threads, the corresponding cores (e.g., core 230 and/or core 232) can execute the instructions corresponding to the tasks. In some implementations, each of the cores can execute one thread at a time such that switching from one thread to another thread can involve a context switch. In some examples, a context switch can generally refer to saving a state (e.g., data, instructions, and/or other operating parameters) of a first thread for later execution and restoring a state of a second thread to continue executing the second thread. For example, core 230 can execute thread 240A, save the state of thread 240A to registers 218, restore a state of thread 240B from registers 218, and continue with thread 240B.

In some implementations, a hardware error system such as MCA can detect and report hardware errors (e.g., parity errors for stored data/values, cache errors, bus errors, buffer errors, etc.), such as through an error interrupt, with additional error data stored in an MSR or other register. In some examples, the hardware error can corrupt a shared resource (e.g., a cache, a memory, etc.). For example, in FIG. 2, a hardware error can cause corruption of data in registers 218 (e.g., by changing stored bit values). Without corrective action in response to this error, the corrupted data can spread, for example via a context switch to core 232, which can then spread to a cache/memory, other registers, etc. As the data corruption spreads, system 200 can reach a state in which continued execution on all threads can become unreliable. Accordingly, to prevent such a scenario, a control circuit (e.g., control circuit 112) can issue a shutdown command as an appropriate response.

In another example, an error can correspond to a particular thread and/or core. For example, control circuit 112 can receive an error interrupt for thread 240A. If left unchecked, the error in thread 240A can potentially create a data corruption that can spread to shared resources (e.g., from a context switch, continued execution of tasks, etc.). In some examples, control circuit 112 can issue the shutdown command, which can undesirably shut down other threads (e.g., thread 240B, thread 242A, and/or thread 242B) not exhibiting errors. However, if thread 240A can be individually shut down or otherwise prevented from continued execution, the error and potential data corruption can remain localized to thread 240A such that the other threads can continue execution and avoid costly down time of a shutdown of system 200. Accordingly, in some implementations, control circuit 112 can isolate thread 240A to decline or otherwise prevent thread 240A from further execution-related requests (e.g., tasks/instructions, interrupts, sending/receiving data through a data fabric, other events), prevent thread 240A from context switching and/or committing data (e.g., storing data from a current processing state to a data storage device), as well as notify operating system 260 that thread 240A is not available for assigning tasks. In some implementations, control circuit 112 can isolate a thread such as thread 240A by marking the thread as isolated (e.g., updating an isolation status of the thread to indicated isolation).

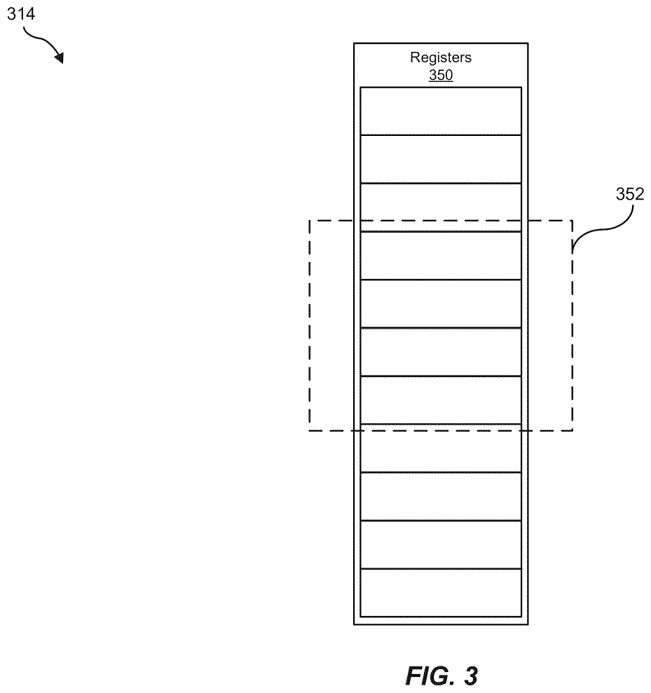

FIG. 3 illustrates an example diagram representing a windowed register 314 which can correspond to register 114. In some examples, windowed register 314 can correspond to multiple physical registers 350. In some examples, a control circuit (e.g., control circuit 112) can access a portion of registers 350, such as a sub-portion or window 352 of registers. Window 352 can be defined by a pointer, counter, or other indicator of the first register (from registers 350) of window 352 along with a window size, which can be predetermined (e.g., corresponding to a number of architectural registers or other number of registers) or a configurable parameter, and in some implementations corresponds to MSR size.

In some examples, control circuit 112 can mark a thread as isolated by storing the isolation status in one of registers 350. For instance, control circuit 112 can store a bit, flag, and/or other value to indicate that a corresponding thread is isolated. In some examples, control circuit 112 and/or other appropriate controller can initialize registers 350, for instance during a system boot, to indicate each thread as not isolated, as well as establish an indexing of threads to registers. For example, each thread can have a corresponding register for its isolation status. However, in some examples, a number of threads can exceed the window size such that using windowed register 314 allows each thread to have its own register for its isolation status, and by updating the pointer, access each register as needed by iterating through different windows. In other implementations, isolated threads can be tracked by storing a thread identifier in registers 350 such that registers 350 can include only isolated threads. Moreover, the indexing can be reconfigured as needed. Windowed register 314 can be visible to the operating system, threads, and/or controllers for maintaining isolation statuses for all threads. Accordingly, threads marked as isolated in registers 350 can be identified and isolated as described herein.

In some implementations, isolating a faulty thread can include reporting the isolation status of the isolated thread to an operating system (e.g., operating system 260) to respond accordingly (e.g., kill processes on the isolated thread, suspend scheduling further tasks to the isolated thread, account for the unavailability of the isolated thread for workloads, etc.). Although without isolation the faulty thread could report its own faulty status to the operating system (e.g., using an interrupt), the faulty thread can be unreliable such that reporting (and/or other related actions) can cause another error interrupt for the faulty thread, which can result in an error loop (e.g., nested machine checks) or other fatal error requiring shutdown. Similarly, having the isolated thread report its own isolation status to the operating system can be unreliable in some examples.

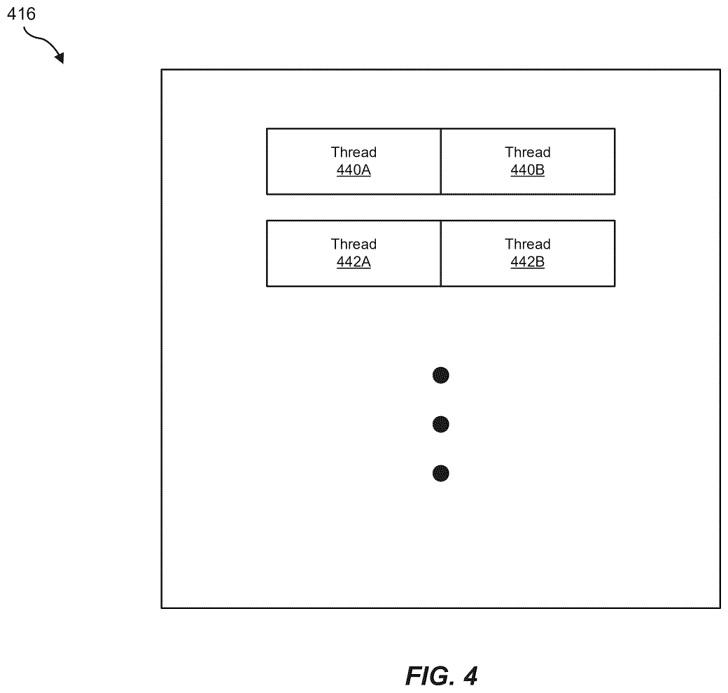

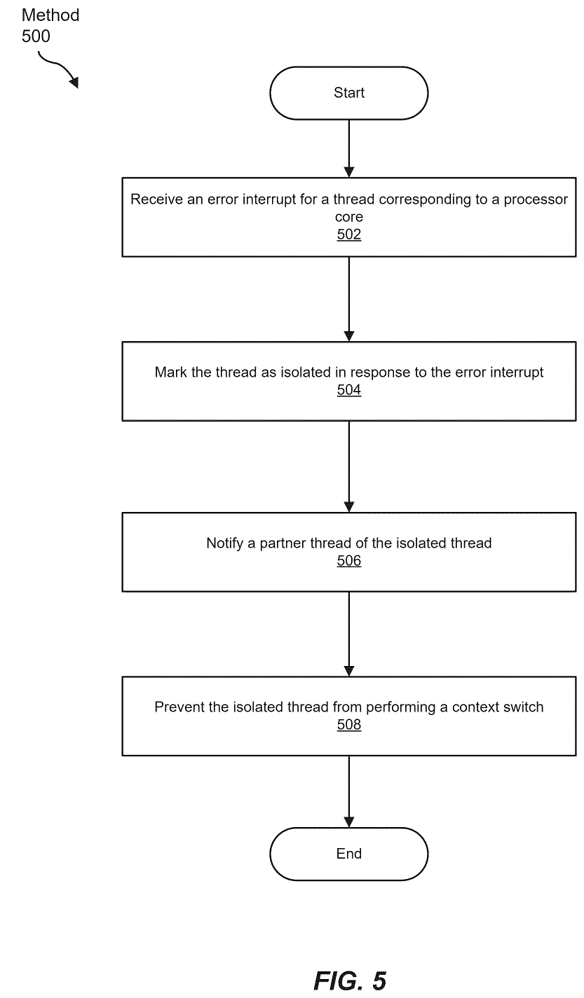

In some implementations, a thread can be assigned a partner thread for reporting an isolation status. Turning to FIG. 4, a register 416 (corresponding to register 116) can represent one or more registers for storing partner mappings for one or more threads. For example, a thread 440A (corresponding to thread 240A) can be partners with a thread 440B (corresponding to thread 240B), and a thread 442A (corresponding to thread 242A) can be partners with a thread 442B (corresponding to thread 242B). Register 416 can include additional partner mappings as needed, which can be stored in any appropriate mapping. In one example, each register of register 416 can correspond to or otherwise be indexed to each thread, and store an identifier/index of the partner thread. In another example, each register of register 416 can include two identifiers corresponding to the paired threads. In addition, in some examples register 416 can correspond to an MSR and can further correspond to a windowed register.

In some examples, the partner mappings can be established during a system boot. For example, an operating system (e.g., operating system 260) and/or a control circuit (e.g., control circuit 112) can establish partner mappings and store the partner mappings in register 416. Although FIG. 4 illustrates pairs of partners corresponding to the matching physical cores (e.g., core 230 and core 232, respectively), in other examples, other partner mappings can be used. For instance, threads can be partnered across different cores, threads can be partnered to more than one thread, and partner mapping can be unidirectional (e.g., thread 440A having thread 440B as its partner, and thread 440B having thread 442A as its partner). Moreover, the partner mappings can be changed and/or reestablished as needed. Register 416 can be visible to the operating system, threads, and/or controllers.

Having partner mappings established (e.g., in register 416), control circuit 112 can mark a thread (e.g., thread 440A) as isolated (e.g., by updating an isolation status of thread 440A in an appropriate register such as register 314) and further notify a partner thread of the isolated thread (e.g., thread 440B being the partner thread to thread 440A). Control circuit 112 can identify the partner thread from register 416 and send a notification (e.g., an interrupt or other message) to the partner thread.

The partner thread can report the isolation status to avoid the isolated thread from performing further actions including reporting its own isolation. For example, thread 440B can report the isolation of thread 440A (e.g., via an interrupt or other message) to operating system 260. In some implementations, the notification received by thread 440B from control circuit 112 does not specifically identify thread 440A. In such implementations, thread 440B can determine its partner thread (e.g., based on register 416) and further determine or confirm the isolation status of thread 440A (e.g., based on register 314). To isolate thread 440A, a data fabric (e.g., represented by control circuit 112) can deny further requests to/from thread 440A. In addition, control circuit 112 can, in some examples, prevent thread 440A from performing actions such as context switching, sending/writing data, etc. Further, in some implementations, operating system 260 can recognize the isolation status of thread 440A (e.g., via direct identification from thread 440B and/or a general notification from thread 440B followed by accessing register 314 to identify all isolated threads) and accordingly update a policy for thread 440A, such as cancelling/suspending tasks to thread 440A, which in some examples can prevent conflicts between operating system 260 sending requests to thread 440A and the data fabric having to deny such requests.

FIG. 5 is a flow diagram of an exemplary computer-implemented method 500 for core isolation for errors. The steps shown in FIG. 5 can be performed by any suitable device, computer-executable code and/or computing system, including the system(s) illustrated in FIGS. 1-4. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein receive an error interrupt for a thread corresponding to a processor core. For example, control circuit 112 can receive an error interrupt (e.g., machine check) for a thread, such as thread 240A. In some examples, a hardware error associated with thread 240A and/or the corresponding physical core can be detected and reported as the error interrupt (e.g., as part of an MCA process). Further, in some examples, the error interrupt can directly identify thread 240A, and in other examples, control circuit 112 can identify or otherwise look up the thread corresponding to the received error interrupt. In yet other examples, the error interrupt can correspond to a nested error interrupt.

At step 504 one or more of the systems described herein mark the thread as isolated in response to the error interrupt. For example, control circuit 112 can mark thread 240A as isolated in response to the error interrupt.

The systems described herein can perform step 504 in a variety of ways. In one example, marking the thread as isolated can marking the thread as isolated in a register configured to store isolation statuses of threads (e.g., register 114 and/or register 314). For example, control circuit 112 can update the isolation status, for instance from a default or non-isolated status to the isolated status, in register 114.

At step 506 one or more of the systems described herein notify a partner thread of the isolated thread. For example, control circuit 112 can notify a partner thread (e.g., thread 240B) of thread 240A.

The systems described herein can perform step 506 in a variety of ways. In one example, notifying the partner thread can include identifying the partner thread of the isolated thread from a register configured to store partner mappings for threads (e.g., register 116 and/or register 416). For instance, control circuit 112 can look up the partner thread in register 116.

At step 508 one or more of the systems described herein prevent the isolated thread from performing a context switch. For example, control circuit 112 (and/or a corresponding data fabric) can prevent thread 240A from performing a context switch and/or another operation that can spread potentially corrupt data. In other words, thread 240A can be isolated from further requests as well as prevented from performing further operations.

The systems described herein can perform step 508 in a variety of ways. In one example, the corresponding physical core can be prevented from context switching to thread 240A or otherwise prevented from accessing shared resources. In addition, resources used by thread 240A (e.g., registers, and in some examples, private portions of cache and/or memory) can also be isolated and/or flushed.

In some examples, method 500 can further include reporting an isolation status of the isolated thread. For instance, the partner thread can report the isolation status, such as to an operating system (e.g., operating system 260), data fabric, and/or other controllers. In some examples, the reporting can be active (e.g., via an interrupt or message from the partner thread). In some examples, the reporting can be passive (e.g., via a general notification and/or via the updated isolation status that can be visible).

In some examples, reporting the isolation status can include identifying, by the partner thread, the isolated thread based on the partner mappings in the register (e.g., register 116 and/or register 416). In some examples, reporting the isolation status of the isolated thread can include identifying, by the partner thread, the isolation status from the register (e.g., register 114 and/or register 314).

As detailed above, containing a core-contained error (e.g., an error that has not corrupted shared system resources such as the cache/memory sub-system) to the core/thread on which it occurred can allow avoiding a sync flood (e.g., system shutdown) on those errors. However, many core-contained errors can be the result of defects in the core such that continued execution on the faulty/error cores can be unreliable. The systems and methods described herein allow the containment and signaling of these errors to be more reliable. This approach can be applied to a bare-metal system (e.g., directly on the system hardware) as well as a virtualized system.

There are several example error scenarios contemplated, in reference to, for instance, an MCA platform. In one example, an error occurs once and not again. This scenario has two components: sending the #MC/shutdown event to the operating system (OS) and/or hypervisor (HV), and ensuring the ucode #MC handler executes reliably (e.g., corresponding to “skip guest save” or preventing data saving or context switch as described herein).

In another example, an error causes a machine check or shutdown. Handling the machine check can trigger another #MC/shutdown and the core can get stuck in a loop. The “core isolation” describe herein can address this scenario.

Accordingly, the systems and methods described herein can allow other cores to continue normal operation in response to a core-contained error. Given a growing number of cores (and threads) in computing systems, preventing a core/thread from shutting down all cores/threads can advantageously improve computing efficiency, including more efficient use of computing resources as well as allowing more usage of computing resources (rather than having system downtime and/or delay for system reboot). Additionally, running workloads that did not consume the error can continue without having to stop for shutdown/reboot.

Moreover, the systems and methods described herein allow hardware faults to be contained to a single process/virtual machine (VM) (e.g., tenant/guest in a system of multiple guests managed by a HV). This advantageously avoids one guest from bringing down another guest due to a hardware fault. The systems and methods described herein further allow signaling of this fault to be reliable, and avoid a system hang or a system reboot.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAS that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a control circuit configured to:
mark a thread as isolated in response to an error interrupt corresponding to the thread; and
send a notification of isolating the thread to a partner thread of the isolated thread.

2. The device of claim 1, further comprising a register for storing an isolation status for threads, wherein the control circuit is configured to mark the isolated thread as isolated in the register.

3. The device of claim 2, wherein the register corresponds to a windowed register.

4. The device of claim 2, wherein the register is configured to maintain isolation statuses for all threads.

5. The device of claim 1, further comprising a register for storing partner mappings.

6. The device of claim 5, wherein the control circuit is further configured to identify the partner thread based on partner mappings in the register.

7. A system comprising:
a plurality of processor cores corresponding to threads;
a first register for storing an isolation status for the threads;
a second register for storing partner mappings for the threads; and
a control circuit configured to:
mark a thread as isolated in the first register in response to an error interrupt corresponding to the thread;
identify a partner thread of the isolated thread based on the second register; and
send a notification of isolating the thread to the partner thread of the isolated thread.

8. The system of claim 7, wherein an operating system of the system establishes the partner mappings on a boot of the system.

9. The system of claim 8, wherein the partner thread is configured to report the isolated thread to the operating system.

10. The system of claim 7, wherein the control circuit is configured to decline execution-related requests to the isolated thread.

11. The system of claim 7, wherein the first register is configured to maintain isolation statuses for all threads.

12. The system of claim 7, wherein the partner thread is configured to identify the isolation status from the first register in response to the notification.

13. The system of claim 12, wherein the partner thread is further configured to identify the isolation status from the first register based on identifying a partner mapping in the second register.

14. The system of claim 7, wherein the first register corresponds to a windowed register.

15. A method comprising:
receiving an error interrupt for a thread corresponding to a processor core;
marking the thread as isolated in response to the error interrupt;
notifying a partner thread of the isolated thread; and
preventing the isolated thread from performing a context switch.

16. The method of claim 15, further comprising reporting an isolation status of the isolated thread.

17. The method of claim 16, wherein marking the thread as isolated further comprises marking the thread as isolated in a register configured to store isolation statuses of threads.

18. The method of claim 17, wherein reporting the isolation status of the isolated thread further comprises identifying, by the partner thread, the isolation status from the register.

19. The method of claim 16, wherein notifying the partner thread further comprises identifying the partner thread of the isolated thread from a register configured to store partner mappings for threads.

20. The method of claim 19, wherein reporting the isolation status further comprises identifying, by the partner thread, the isolated thread based on the partner mappings in the register.
